(19) United States
(12) Patent Application Publication
(10) Pub. No.: US 2019/0182402 A1
(43) Pub. Date: Jun. 13, 2019

(54) PRINT SCANNER AND TRANSLATOR

(71) Applicant: Nedal Shriesher, Clovis, CA (US)

(72) Inventor: Nedal Shriesher, Clovis, CA (US)

(21) Appl. No.: 15/834,454

(22) Filed: Dec. 7, 2017

(51) Int. Cl. H04N 1/107; G06F 17/28

(52) U.S. Cl. CPC H04N 1/1075; H04N 2201/0081; G06F 17/2863

(57) ABSTRACT

A handheld print scanner and translator may be shaped as a working pen, and may provide for a scanner on one side of its body and a display screen on the other side of its body. In some embodiments, the present invention may provide for a button wheel on the present invention's base that may be configured to operate the scanner and determine what form or type of output may be displayed on the display screen. In some embodiments, a processor may translate one or more scanned words or phrases from a printed page, whether physical page or electronic screen, and may display a translation of the text on the display screen.

### CROSS-REFERENCE TO RELATED APPLICATION

Not applicable.

### TECHNICAL FIELD

The present invention relates generally to the field of reading devices and more specifically relates to a handheld print scanner and translator.

### BACKGROUND

One of the most arduous tasks a person faces when learning a language is committing a sufficient amount of words to memory so as to allow the person to express herself or himself regardless of the situation or subject. This is no simple task in any language, but many consider English to be one of the harder languages in this respect. Moreover, English has a vast number of words: the most of any language according to some scholars. English presents a particularly complex lexicon because it has many different roots and influences, including Old English and Latin, which results in a huge variety in its words' spellings. Additionally, many English words mean essentially the same thing, but with subtle differences that are often lost on those who do not speak English as their native language or preferred language.

A need therefore exists for an on-the-fly translator that can assist non-native speakers when they are reading a text in a second language.

One attempt to meet this need can be seen with respect to U.S. Pat. No. 6,270,013, incorporated by reference in its entirety herein, which generally discloses a handheld optical scanner and translator. While this disclosure is conveniently pen-shaped, its reliance on a rolling head limits its effectiveness.

Another attempt can be seen with respect to U.S. Pat. No. 9,143,638, incorporated by reference in its entirety herein, which generally discloses a handheld scanner. While this disclosure does provide for a pen-like scanner for printed text, it generally requires an intermediary screen such as a computer screen, rather than displaying the text, or translated text, on the device itself.

Yet another attempt can be seen with respect to U.S. Pat. No. 9,681,016, incorporated by reference in its entirety herein, which generally discloses a scanning device that can discern and analyze handwritten markups on a page. While this disclosure does provide for a handheld print-scanning unit, it fails to provide for adequate on-the-go translation functions.

Various attempts have been made to solve the problems which may be found in the related art but have thus far been unsuccessful. A need exists for a new handheld print scanner and translator, in some embodiments shaped as a pen, and in some other embodiments configured as a working pen, scanner, and display device, to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name are herein meant to include or encompass all equivalents for such elements. Such equivalents are contemplated for each element named in its particular herein.

The present invention relates to a print scanner and translator that overcomes the deficiencies of the prior art. It is contemplated that the present invention may provide on-demand text translation of written materials.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel print scanner and translator. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a handheld print scanner and translator that enables a user to use the present invention as a pen, with a functioning ink-delivering pen element in the present invention's tip (or “end”), and when desired, can scan a portion of text using the present invention's scanner. After scanning the text, the present invention may display the text in a translated form. By way of non-limiting example, in some embodiments, a user may scan a portion of text in English and the present invention may display the text's Spanish, or other second-language, meaning of the text on the present invention's screen. In some embodiments, the present invention may provide for translation of digital, rather than traditional physical, printed text. By way of illustration and not limitation, in such a configuration, the present invention's scanner may be configured to scan and detect print on an electronic screen, such as by way of illustration, an e-reader, e-book, mobile device, or electronic screen. In some embodiments, the present invention may comprise a pen-shaped device that is not configured as a pen, but has the scanner where the ink-delivering pen point would have been in the present invention's end. In any configuration, the present invention may be configured to scan or slide over a word printed in a textbook, newspaper, e-reader, or other format, and display a translated version of the word, a dictionary definition of the word, or both, on the pen's small screen.

More specifically, in some embodiments, the present invention may resemble or appear to be a good pen with a quality metal body. In some embodiments, the present invention may provide for a small scanner or camera on one side and a small display screen on the opposite side, so as to configure the present invention to read a text selection and display a translated definition of the word when the present invention's scanner is held over a printed word. The present invention may provide for a button mouse wheel on one end of the pen, which can be clicked to scan and twisted for scrolling or may be held down when scanning an individual word. In various embodiments, the present invention may read, translate, and display words in any known language, such as by way of illustration and not limitation, English, Spanish, Italian, Hindi, Chinese, Japanese, French, Russian, Portuguese, and so forth. In some embodiments, the present invention may display the definitions of English words in English, or translate English to Spanish, English to Arabic, English to Chinese, English to Japanese, and to other languages, as well as the reverse, like Spanish to English, Arabic to English, and so forth.

The unique features of the present invention may provide the following benefits for one or more consumers: it may assist non-native English speakers with reading English enhance their comprehension of the language and it may save users time by eliminating the need to stop reading in order to find the meanings of troublesome words in a dictionary. It may also provide a convenient tool for non-native English speakers to use when reading English. It may also be versatile enough to be used for both hard copy printed books as well as e-books. It may be used to supply the definitions of words without having to reach for a dictionary. It may enable users to read faster and with greater comprehension, and may eliminate many of the frustrations experienced when reading by those who are learning English.

### BRIEF DESCRIPTION OF THE DRAWINGS

These and other features, aspects and advantages of the present invention will become better understood with regard to the following description, appended claims, and accompanying figures where:

FIG. 1 shows a side perspective view of a handheld print scanner and translator pen in accordance with one embodiment of the invention.

FIG. 2 shows a side perspective view of a handheld print scanner and translator pen in accordance with one embodiment of the invention.

FIG. 3 shows a top perspective view of a handheld print scanner and translator pen in accordance with one embodiment of the invention.

### DETAILED DESCRIPTION

The present invention overcomes the limitations of the prior art by providing a new and more effective handheld print scanner and translator pen.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

In some embodiments, the present invention may comprise a print scanner and translator having a body having a first side, a second side, an end and a base. The present invention may also provide for a scanner disposed on the first side, wherein the scanner is configured to detect, capture, and transmit textual data and a display screen disposed on the second side that is configured to display a translated word or phrase, a definition, or other text. The present invention may further comprise a button or a button wheel disposed on the base, and at least one processor, wherein the at least one processor is configured to accept and analyze captured data from the scanner, translate the data into an output, and transmit the output to the display screen. The present invention may further comprise a tip disposed in or on the end.

In some embodiments, the body may be shaped as a pen, and may in some embodiments comprise a working pen with an ink delivery element that enables ink to flow from the pen tip. Furthermore, in some embodiments, the scanner may be configured to detect, capture, and transmit text printed on a page, on an electronic screen, or both. In some embodiments, the processor is configured to translate data comprising a word from a first language to a second language, a series of words from a first language to a second language, a definition of one or more words, or any combination of these or other similar functions found to be common amongst textual translation devices known in the art.

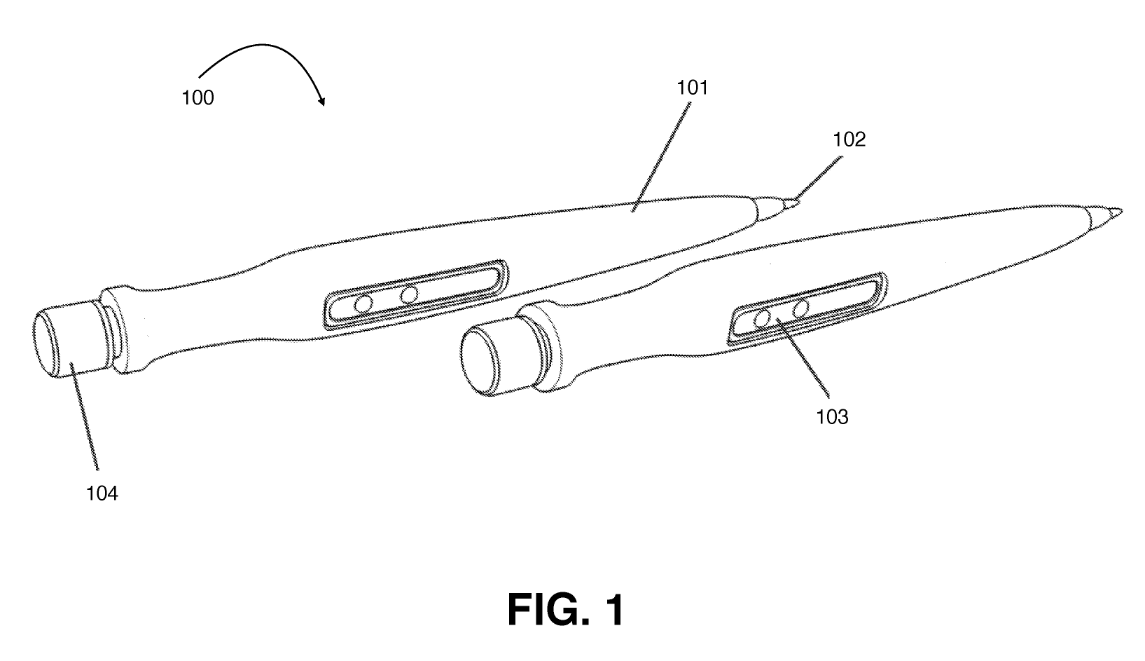

Turning attention to FIG. 1, a side perspective view of a handheld print scanner and translator pen in accordance with one embodiment of the invention is shown. In the embodiment depicted, a viewer may perceive handheld print scanner and translator pen 100, body 101, pen tip 102, scanner camera 103, and button wheel 104.

In some embodiments, body 101 may be of any shape known in the writing arts, such as but not limited to, a pen, pencil, highlighter, ink pen, quill, laser pointer, felt-tipped pen, marker, dry-erase marker. In some embodiments, body 101 may be a of any real or whimsical shape, such as a pen light, a recipe box, a tongue depressor, a letter opener, a deck of cards, or any other design.

Correspondingly, any appropriate element may be substituted for pen tip 102, such as but not limited to a highlighter tip, a quill tip, and so forth.

Scanner camera 103 (or elsewhere simply “scanner”) may be any scanner known in the art that has a camera or other text-sensing function and the ability to communicate with a processor. Scanner 103 may also be configured to detect individual words, phrases, or paragraphs. Scanner 103 may use any capturing and transmitting applications known in the art.

Button wheel 104 (or “button mouse wheel” elsewhere herein) may, in some embodiments, be used to manipulate the various functions of the present invention. By way of illustration and not limitation, button wheel 104 may, in some embodiments, be held down when scanning an individual word or phrase, so as to cause the scanning function to start when a user depresses button wheel 104, scan while the user holds down button wheel 104, and cease scanning when the user releases button wheel 104. In some embodiments, depressing or “clicking” button wheel 104 may cause the present invention to power on, and clicking button wheel 104 may cause the present invention to power off.

In some embodiments, button wheel 104 may be rotated to select from various functions or options of the present invention. By way of illustration and not limitation, button wheel 104 may be rotated to select the language of the text and the “destination” language, or the language into which the present invention may translate the selected text. Button wheel 104 may also be used to select from print or electronic text medium to be scanned. In some embodiments, a user may rotate button wheel 104 to a setting that may cause the present invention to display a meaning for a word, such as a definition or a synonym, in addition to or in substitution for the translated version of the selected word or text.

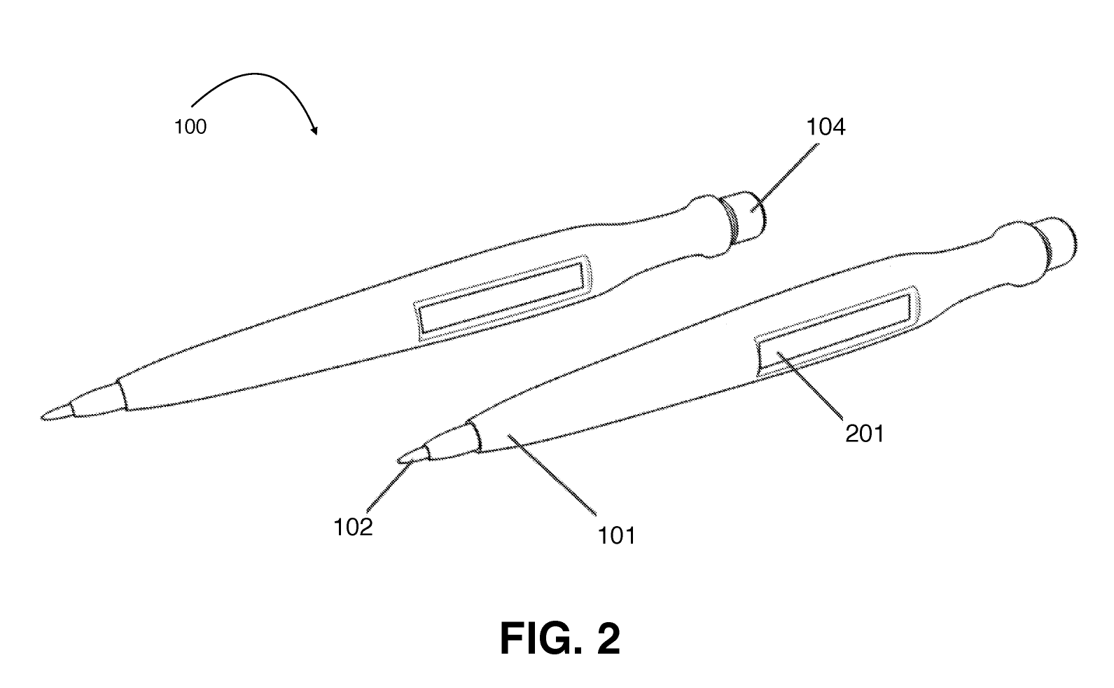

With respect to FIG. 2, a side perspective view of a handheld print scanner and translator pen in accordance with one embodiment of the invention is shown. In the embodiment depicted, a viewer may perceive display screen 201, as well as body 101, pen tip 102, scanner camera 103, and button wheel 104.

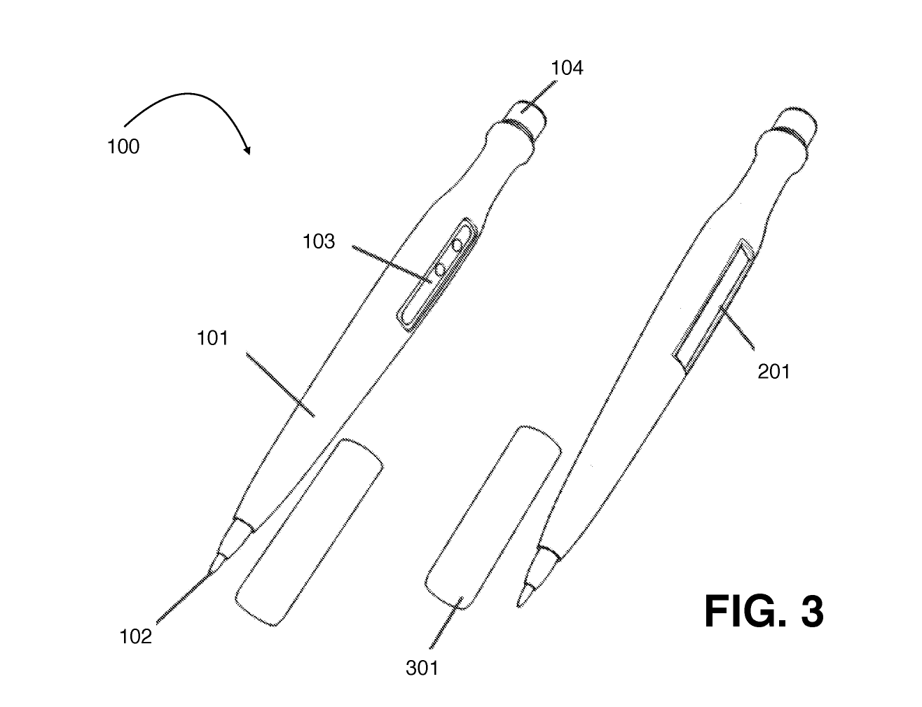

With respect to FIG. 3, a top perspective view of a handheld print scanner and translator pen in accordance with one embodiment of the invention is shown. In the embodiment depicted, a viewer may perceive pen cap 301, as well as display screen 201, as well as body 101, pen tip 102, scanner camera 103, and button wheel 104. It is contemplated that pen cap 301 may match the version of body 101 provided-for, such as by way of illustration and not limitation, a cap for a pen (as shown in FIG. 3), or a highlighter cap, or even an ink well.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the handheld print scanner and translator pen generally described herein has been disclosed in connection with a number of embodiments shown and described in detail, various modifications should be readily apparent to those of skill in the art.

What is claimed is:

1. A print scanner and translator, comprising:
a body having a first side, a second side, an end and a base;
a scanner disposed on the first side, wherein the scanner is configured to detect, capture, and transmit textual data;
a display screen disposed on the second side;
a button wheel disposed on the base;
at least one processor, wherein the at least one processor is configured to accept and analyze captured data from the scanner, and wherein the at least one processor is configured to translate the data into an output, and wherein the at least one processor is configured to transmit the output to the display screen; and
a tip disposed in the end.

2. The print scanner and translator of claim 1, wherein the body is shaped as a pen.

3. The print scanner and translator of claim 2, wherein the tip is a pen tip.

4. The print scanner and translator of claim 3, wherein the pen tip is a working pen tip.

5. The print scanner and translator of claim 1, wherein the scanner is configured to detect, capture, and transmit text printed on a page.

6. The print scanner and translator of claim 1, wherein the scanner is configured to detect, capture, and transmit text printed on an electronic screen.

7. The print scanner and translator of claim 1, wherein the processor is configured to translate data comprising a word from a first language to a second language.

8. The print scanner and translator of claim 1, wherein the processor is configured to translate data comprising a series of words from a first language to a second language.

9. The print scanner and translator of claim 1, wherein the output is a translation of one or more words.

10. The print scanner and translator of claim 1, wherein the output is a definition of one or more words.
